(19) United States
(12) Patent Application Publication
(10) Pub. No.: US 2011/0148931 A1
(43) Pub. Date: Jun. 23, 2011

(54) APPARATUS AND METHOD FOR CONTROLLING SIZE OF DISPLAY DATA IN PORTABLE TERMINAL

(75) Inventor: Mu-Sul KIM, Busan (KR)

(73) Assignee: SAMSUNG ELECTRONICS CO. LTD., Suwon-si (KR)

(21) Appl. No.: 12/968,628

(22) Filed: Dec. 15, 2010

(30) Foreign Application Priority Data
Dec. 18, 2009 (KR) 10-2009-0126768

(51) Int. Cl. G06T 3/40

(52) U.S. Cl. 345/660

(57) ABSTRACT

An apparatus and method for controlling a size of display data in a portable terminal are provided. The apparatus includes a controller for automatically controlling a size of display data according to a preset user's reference eyesight. Accordingly, the size of displayed text can be automatically expanded or reduced in the portable terminal based on the user's eyesight or a distance of the user.

### PRIORITY

This application claims the benefit under 35 U.S.C. §119(a) of a Korean patent application filed in the Korean Intellectual Property Office on Dec. 18, 2009 and assigned Serial No. 10-2009-0126768, the entire disclosure of which is hereby incorporated by reference.

### BACKGROUND OF THE INVENTION

1. Field of the Invention

The present invention relates to an apparatus and method for automatically controlling a size of display data in a portable terminal. More particularly, the present invention relates to an apparatus and method for automatically expanding or reducing a size of displayed text in a portable terminal based on a user's eyesight or a distance of a user.

2. Description of the Related Art

Recently, portable terminals, a necessity to modern people, have become widely used. Service providers or system manufacturers have competitively developed products (or services) in order to differentiate from other enterprises.

For example, the portable terminals have evolved into multimedia devices with functions such as phone books, games, short messages, Electronic mail (E-mail) messages, morning wakeup calls, Moving Picture Expert Group (MPEG)-1 or 2 Audio Layer 3 (MP3) players, schedule management functions, digital cameras, wireless Internet services, and the like, and provide a variety of services.

Accordingly, users of the portable terminals can read books or listen to music even without carrying separate multimedia devices.

The portable terminals have decreased in size for portability. As a result, a display unit displaying an operation state of the portable terminal has decreased in size as well.

Thus, in order to determine contents displayed on the display unit of a small size, a user having poor eyesight has to endure inconveniences of expanding the displayed contents using an assistant instrument such as a magnifying glass.

This occurs because the portable terminal displays data of a fixed size on the display unit in a small size which causes a problem in that a nearsighted or farsighted person has to control a distance with the portable terminal and focus on displayed contents or a display data size by entering a specific menu and setting the display data size.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for automatically controlling a size of a display text in a portable terminal.

Another aspect of the present invention is to provide an apparatus and method for automatically controlling a size of a display text based on a user's eyesight in a portable terminal.

A further aspect of the present invention is to provide an apparatus and method for automatically controlling a size of a display text based on a distance between a user and a portable terminal in the portable terminal.

The above aspects are achieved by providing an apparatus and method for controlling a size of display data in a portable terminal.

In accordance with an aspect of the present invention, an apparatus for controlling a size of display data in a portable terminal is provided. The apparatus includes a controller for automatically controlling a size of display data according to a preset user's reference eyesight.

In accordance with another aspect of the present invention, a method for controlling a size of display data in a portable terminal is provided. The method includes automatically controlling a size of display data according to a preset user's reference eyesight.

In accordance with still another aspect of the present invention, an apparatus for controlling a size of display data in a portable terminal is provided. The apparatus includes a display unit for displaying data, a reference eyesight determining unit for measuring a user's eyesight for the display data, and a controller for changing a display condition of the data displayed on the display unit according to the measurement result of the reference eyesight determining unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings in which:

FIG. 1 is a block diagram illustrating a construction of a portable terminal for controlling a text size according to t an exemplary embodiment of the present invention;

FIG. 2 is a flow diagram illustrating a process of changing a data display condition in a portable terminal according to an exemplary embodiment of the present invention;

FIG. 3 is a flow diagram illustrating a process of changing a data display condition in a portable terminal according to an exemplary embodiment of the present invention;

FIG. 4A is a diagram illustrating a screen displaying a general size text in a portable terminal according to an exemplary embodiment of the present invention;

FIG. 4B is a diagram illustrating a screen displaying a text expanded in size in which a user cannot recognize the text in a portable terminal according to an exemplary embodiment of the present invention; and

FIG. 4C is a diagram illustrating a screen displaying a text reduced in size in which a user cannot recognize the text in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for automatically controlling a size of a display text according to a user's eyesight or a distance of a user in a portable terminal. Also, the portable terminal is a terminal capable of displaying text data, image data, and the like on a display unit, and may include a mobile communication terminal, a Portable Digital Assistant (PDA), a portable computer, a Netbook that is the mixed word of ‘Internet’ and ‘notebook’, a digital camera, a Portable Multimedia Player (PMP), an electronic book, and the like. The following description is made with a general construction of the mobile communication terminal.

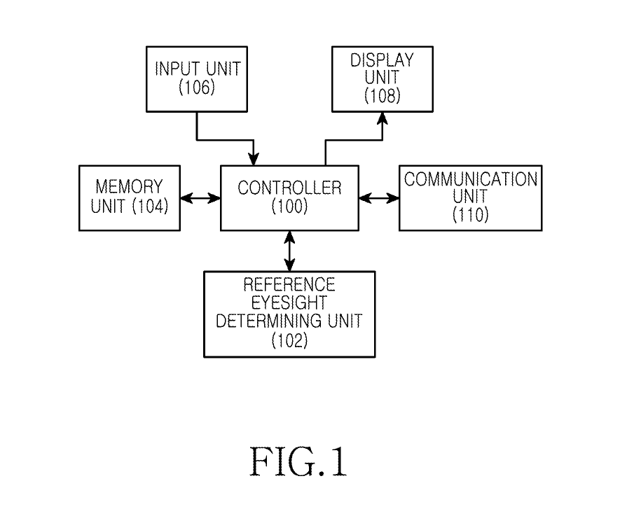

FIG. 1 is a block diagram illustrating a construction of a portable terminal for controlling a text size according to an exemplary embodiment of the present invention.

Referring to FIG. 1, the portable terminal may include a controller 100, a reference eyesight determining unit 102, a memory unit 104, an input unit 106, a display unit 108, and a communication unit 110. The portable terminal may include additional units that are not illustrated for sake of clarity. Similarly, the functionality of two or more of the above units may be integrated into a single component.

The controller 100 of the portable terminal performs a function of controlling a general operation of the portable terminal. According to an exemplary embodiment of the present invention, the controller 100 processes to automatically control a size of a display text according to a user's eyesight or a distance of the user.

That is, the controller 100 determines a reference eyesight representing the user's eyesight or the distance of the user, and determines a text size adjustment value corresponding to the reference eyesight.

Thereafter, the controller 100 processes to expand or reduce a text intended to be displayed at a size corresponding to the determined text size adjustment value, within a preset range.

At this time, in a case where the portable terminal is at a far distance from a user, the controller 100 determines that it has to expand the size of the text intended to be displayed. In contrast, in a case where the portable terminal is at a near distance from the user, the controller 100 determines that it has to reduce the size of the text intended to be displayed.

Also, in an exemplary implementation, in a case where the eyesight of a user of the portable terminal is less than a preset threshold value, the controller 100 determines that it is difficult to recognize a size of a display text according to the user's poor eyesight and determines that it needs to expand the size of the text intended to be displayed. In contrast, in a case where the eyesight of the user of the portable terminal is greater than the preset threshold value, the controller 100 determines that it will fully recognize a size of a display text according to the user's good eyesight and determines that it needs to reduce the size of the text intended to be displayed.

The reference eyesight determining unit 102 determines a reference eyesight for a change of display data such that, upon data display, a user may easily recognize the display data under the control of the controller 100. Here, the reference eyesight represents a user's eyesight for data displayed in the portable terminal. The reference eyesight may be set in such a manner that the user inputs information measured in an eyesight measurement institute. Also, the reference eyesight may be measured using a specific sensor installed in the portable terminal. For example, in a case where the portable terminal includes a sensor capable of detecting a distance with a user's specific part of the body, the sensor may measure a distance between the portable terminal and the specific part of the body and use the measured distance as the reference eyesight for determining the recognition or non-recognition of the display data.

The memory unit 104 includes a Read Only Memory (ROM), a Random Access Memory (RAM), a flash ROM, and the like. The ROM stores a microcode of a program for processing and controlling the controller 100 and the reference eyesight determining unit 102 and a variety of reference data.

The RAM, a working memory of the controller 100, stores temporary data generated in execution of a variety of programs. The flash ROM stores a diversity of updateable depository data such as a phone book, an outgoing message, an incoming message, and the like. In addition, the memory unit 104 may store a data change value dependent on the reference eyesight according to an exemplary embodiment of the present invention.

The input unit 106 includes numeral key buttons ‘0’ to ‘9’, a menu button, a cancel button (delete), an OK button, a talk button, an end button, an Internet button, navigation key (or direction key) buttons, and a plurality of function keys such as a character input key. The input unit 106 provides key input data corresponding to a key pressed by a user to the controller 100.

The display unit 108 displays state information generated during an operation of the portable terminal, characters, large moving pictures and still pictures, and the like. The display unit 108 may be a color Liquid Crystal Display (LCD), an Active Mode Organic Light Emitting Diode (AMOLED) display, and the like. The display unit 108 may include a touch input device and is applied to a portable terminal of a touch input scheme, and may be used as an input device.

The communication unit 110 performs a function of transmitting/receiving and processing a radio signal of data input/output through an antenna (not illustrated). For example, in a transmission mode, the communication unit 110 performs a function of processing original data through channel coding and spreading, converting the original data into a Radio Frequency (RF) signal, and transmitting the RF signal. In a reception mode, the communication unit 110 performs a function of converting a received RF signal into a baseband signal, processing the baseband signal through de-spreading and channel decoding, and restoring the signal to original data.

A function of the reference eyesight determining unit 102 may be implemented by the controller 100 of the portable terminal. However, these are separately constructed and shown in the present invention as an exemplary construction for description convenience, and should not limit the scope of the present invention. It should be understood by those skilled in the art that various modifications of construction may be made within the scope of the present invention. For example, constructions of the portable terminal may also be processed in the controller 100.

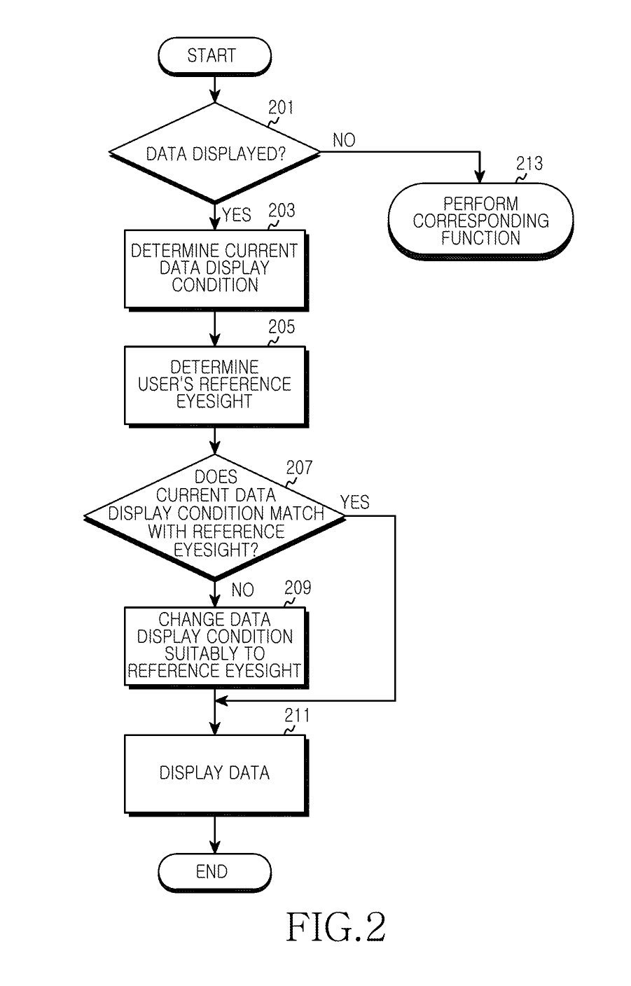

FIG. 2 is a flow diagram illustrating a process of changing a data display condition in a portable terminal according to an exemplary embodiment of the present invention.

Referring to FIG. 2, in step 201, the portable terminal determines if it displays data. Here, the data refers to data displayed on a screen of the portable terminal such as text data, image data, and the like.

If the portable terminal determines that it does not display the data in step 201, the portable terminal proceeds to step 213 and performs a corresponding function (e.g., a standby mode).

On the other hand, if the portable terminal determines that it displays data in step 201, the portable terminal proceeds to step 203 and determines a preset data display condition, i.e., a current data display condition. Here, the data display condition means a size, focus, resolution, and the like of data to be displayed in the portable terminal.

The portable terminal for determining the data display condition proceeds to step 205 and determines a user's reference eyesight. Here, the reference eyesight represents a user's eyesight for data displayed in the portable terminal. The reference eyesight may be set in such a manner that a user inputs information measured in an eyesight measurement institute.

Also, the reference eyesight may be measured using a specific sensor installed in the portable terminal. For example, in a case where the portable terminal includes a sensor capable of detecting a distance with a user's specific part of the body, the sensor may measure a distance between the portable terminal and the specific part of the body, and use the measured distance as the reference eyesight determining the recognition or non-recognition of the display data.

Thereafter, the portable terminal proceeds to step 207 and determines if the current data display condition matches with the reference eyesight. Here, when the current data display condition matches with the reference eyesight, a user of the portable terminal is not inconvenienced when recognizing display data.

In an exemplary implementation, the portable terminal changes the display data according to the data display condition matching with the reference eyesight. In step 207 a process of determining if the portable terminal needs to change a preset data display condition, i.e., if the user can recognize data displayed according to the preset data display condition is provided.

If the portable terminal determines that the current data display condition does not match with the reference eyesight in step 207, in other words, if the portable terminal determines that it needs to change the preset data display condition, the portable terminal proceeds to step 209 and changes the preset data display condition suitable to the user's reference eyesight determined in step 205. Thereafter, the portable terminal proceeds to step 211 and displays data that is changed to meet the changed display condition.

On the other hand, if the portable terminal determines that the current data display condition matches with the reference eyesight in step 207, in other words, if the portable terminal determines that it does not have to change the preset data display condition, the portable terminal proceeds to step 211 and displays data. At this time, the displayed data includes display data meeting the preset data display condition.

The portable terminal then terminates the process.

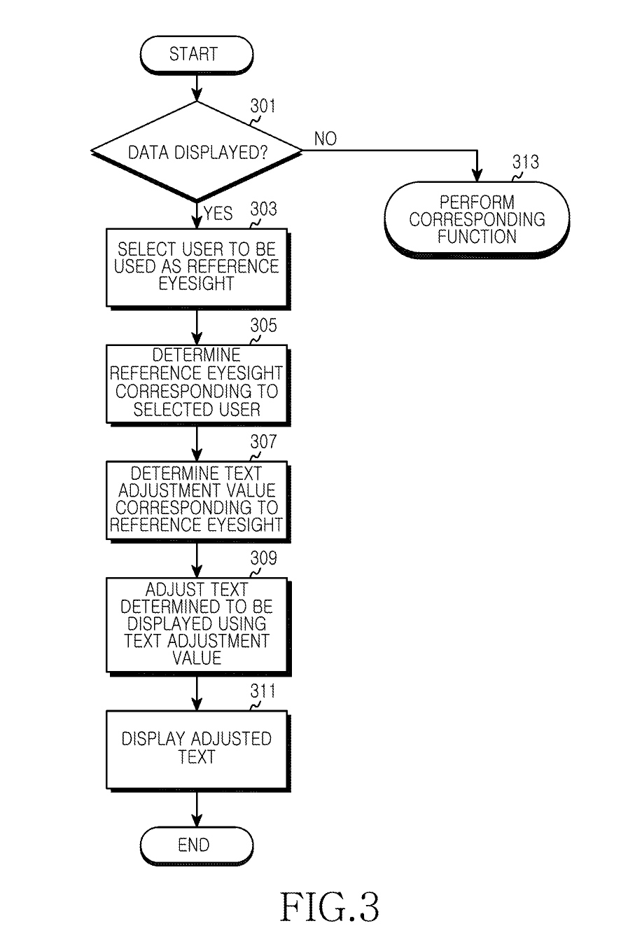

FIG. 3 is a flow diagram illustrating a process of changing a data display condition in a portable terminal according to an exemplary embodiment of the present invention.

Referring to FIG. 3, in step 301, the portable terminal determines if it displays text data.

If the portable terminal determines that it does not display the text data in step 301, the portable terminal proceeds to step 313 and performs a corresponding function (e.g., a standby mode).

On the other hand, if the portable terminal determines that it displays the text data in step 301, the portable terminal proceeds to step 303 and selects a user to be used as a reference eyesight.

In step 303, a plurality of users are allowed to input and set their eyesight in person, and select eyesight to be used as the reference eyesight among the set eyesight of the plurality of users in the portable terminal.

The portable terminal proceeds to step 305 and determines the reference eyesight that corresponds with the selected user. Thereafter, the portable terminal proceeds to step 307 and determines a text adjustment value corresponding to the reference eyesight.

In steps 303 to 307 a size of a text intended to be displayed is changed according to the user's eyesight. The portable terminal may use the text adjustment value dependent on the reference eyesight according to an exemplary embodiment of the present invention as shown in Table 1 below.

TABLE 1

| User | Reference eyesight | Distance | Text adjustment value |
|---|---|---|---|
| A | 1.5 | 30 cm | 0 |
| | 1.5 | 50 cm | +1 |
| B | 2.0 | 30 cm | −1 |
| | 2.0 | 50 cm | 0 |

That is, in a case where a user (A) uses the portable terminal at a distance of 30 cm, the portable terminal maintains a current display text. In a case where the user (A) uses the portable terminal at a distance of 50 cm, the portable terminal corrects (i.e., expands) a value of the current display text by ‘+1’ to fix a problem of the text, in which the text is out of eyesight as the distance becomes far.

In an exemplary implementation, in a case where a user (B) uses the portable terminal at the distance of 30 cm, the portable terminal corrects (i.e., reduces) the expanded and displayed text by ‘−1’ as the user (B) has better eyesight than the user (A).

In addition, the portable terminal may process to control a size of a display text based on a distance rate using a distance between the portable terminal and the user's eyes according to an exemplary embodiment of the present invention.

The portable terminal proceeds to step 309 and controls a size of a text intended to be displayed using the text adjustment value determined in step 307.

That is, in a case where a distance of the user is far or a preset user's eyesight is bad, the portable terminal expands a size of the text intended to be displayed.

In contrast, in a case where the distance of the user is near or the preset user's eyesight is good, the portable terminal reduces the size of the text intended to be displayed.

Thereafter, the portable terminal proceeds to step 311 and displays the adjusted text of step 309 and then terminates the process.

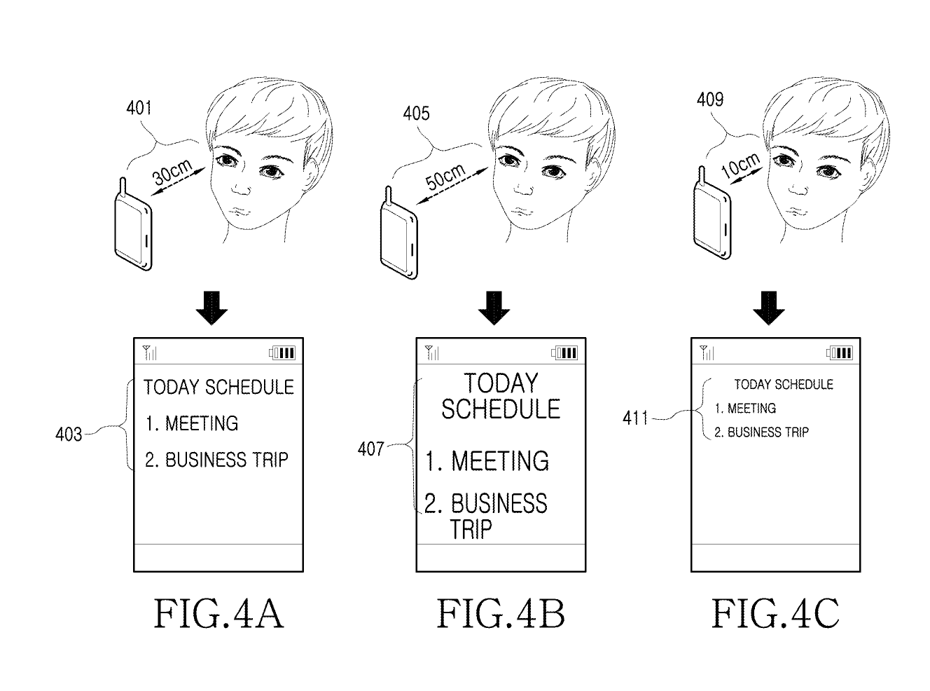

FIGS. 4A-4C are diagrams illustrating a process of adjusting a text size according to a distance of a user in a portable terminal according to an exemplary embodiment of the present invention.

In FIGS. 4A-4C, the process of adjusting the text size according to the distance of the user is described, however, the distance of the user merely is one condition for controlling the text size and, in place of the distance of the user, preset user's eyesight, peripheral brightness, and the like may be used.

FIG. 4A is a diagram illustrating a screen displaying a general size text in a portable terminal according to an exemplary embodiment of the present invention.

Referring to FIG. 4A, the portable terminal is located at a distance of 30 cm from a user. Accordingly, the user of the portable terminal may recognize a text of a general size in the portable terminal.

In a case where the user uses the portable terminal at a distance (e.g., 30 cm) 401 enabling text recognition, the portable terminal is enabled to display a text of a preset size 403.

FIG. 4B is a diagram illustrating a screen displaying a text expanded in size in which a user cannot recognize the text in a portable terminal according to an exemplary embodiment of the present invention.

Referring to FIG. 4B, the portable terminal is located at a distance (e.g., 50 cm) 405 farther than the distance of the portable terminal displaying the text of the general size. In a case where a user uses a portable terminal displaying a text of a fixed size according to the related art, the user has to enter a specific menu and expand the text size which is an inconvenience to the user.

In an exemplary embodiment of the present invention, the portable terminal may automatically expand (407) a size of a display text based on a variation of the distance between the portable terminal and the user's body, and easily recognize the text of the portable terminal, which is at a far distance.

FIG. 4C is a diagram illustrating a screen displaying a text reduced in size in which a user cannot recognize the text in a portable terminal according to an exemplary embodiment of the present invention.

Referring to FIG. 4C, the portable terminal is located at a distance (e.g., 50 cm) 409 nearer than the distance of the portable terminal displaying the text of the general size. In a case where a user uses a portable terminal displaying a text of a fixed size according to the related art, the user has to enter a specific menu and reduce the text size which is an inconvenience to the user.

In an exemplary embodiment of the present invention, the portable terminal may automatically reduce (411) a size of a display text based on a variation of the distance between the portable terminal and the user's body, and recognize the text, which is at a closer distance, in comfort.

As described above, exemplary embodiments of the present invention provide an apparatus and method for automatically controlling a size of a display text according to a user's eyesight or a distance of a user in a portable terminal. Thus, a visual problem which causes astigmatism, nearsightedness, farsightedness, and the like that makes text recognition difficult is resolved, and the entering of a specific menu to change a size of a text in a general portable terminal is resolved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for controlling a size of display data in a portable terminal, the apparatus comprising:
a controller for automatically controlling a size of display data according to preset user's reference eyesight.

2. The apparatus of claim 1, wherein the preset user's reference eyesight comprises a user's eyesight for the display data, and is set in such a manner that a user inputs information measured in an eyesight measurement institute.

3. The apparatus of claim 2, wherein the reference eyesight comprises a distance between the portable terminal and a specific part of the body, and the distance is measured by a sensor for measuring a distance with the body.

4. The apparatus of claim 2, wherein the reference eyesight is defined in the following table:

| User | Reference eyesight | Distance | Text adjustment value |
|---|---|---|---|
| A | 1.5 | 30 cm | 0 |
| | 1.5 | 50 cm | +1 |
| B | 2.0 | 30 cm | −1 |
| | 2.0 | 50 cm | 0 |

5. The apparatus of claim 1, wherein the controller determines a preset data display condition, determines if the display condition matches with the user's reference eyesight, and changes the display condition suitable to the reference eyesight if the display condition does not match with the user's reference eyesight.

6. The apparatus of claim 5, wherein, if the user's eyesight is measured less than the reference eyesight, the controller expands the size of the display data, and
if the user's eyesight is measured greater than the reference eyesight, the controller reduces the size of the display data.

7. A method for controlling a size of display data in a portable terminal, the method comprising:
automatically controlling a size of display data according to a preset user's reference eyesight.

8. The method of claim 7, wherein the preset user's reference eyesight comprises a user's eyesight for the display data and is set in such a manner that a user inputs information measured in an eyesight measurement institute.

9. The method of claim 8, wherein the reference eyesight comprises a distance between the portable terminal and a specific part of the body, and the distance is measured by a sensor for measuring a distance with the body.

10. The method of claim 8, wherein the reference eyesight is defined in the following table:

| User | Reference eyesight | Distance | Text adjustment value |
|---|---|---|---|
| A | 1.5 | 30 cm | 0 |
| | 1.5 | 50 cm | +1 |
| B | 2.0 | 30 cm | −1 |
| | 2.0 | 50 cm | 0 |

11. The method of claim 7, wherein the automatically controlling of the size of the display data according to the preset user's reference eyesight comprises:
determining a preset data display condition;
determining if the display condition matches with the user's reference eyesight; and
if the display condition does not match with the user's reference eyesight, changing the display condition suitable to the reference eyesight.

12. The method of claim 11, wherein the changing of the display condition suitable to the reference eyesight comprises:
if the user's eyesight is measured less than the reference eyesight, expanding a size of display data; and
if the user's eyesight is measured greater than the reference eyesight, reducing the size of the display data.

13. An apparatus for controlling a size of display data in a portable terminal, the apparatus comprising:
a display unit for displaying data;
a reference eyesight determining unit for measuring a user's eyesight for the display data; and
a controller for changing a display condition of the data displayed on the display unit according to the measurement result of the reference eyesight determining unit.

14. The apparatus of claim 13, wherein the reference eyesight comprises a distance between the portable terminal and a specific part of the boy, and the distance is measured by a sensor for measuring a distance with the body.

15. The apparatus of claim 13, wherein the controller determines if a preset data display condition matches with the user's reference eyesight and, if the display condition does not match with the user's reference eyesight, the controller changes the display condition suitable to the reference eyesight.

16. The apparatus of claim 13, wherein, if user's eyesight is measured less than the reference eyesight, the controller expands the size of the display data, and
if the user's eyesight is measured greater than the reference eyesight, the controller reduces the size of the display data.
